(19) United States
(12) Patent Application Publication
(10) Pub. No.: US 2025/0044127 A1
(43) Pub. Date: Feb. 6, 2025

(54) SYSTEMS, METHODS AND ASSEMBLIES FOR SINGLE INPUT SHAPE SENSING

(71) Applicant: OFS Fitel, LLC, Norcross, GA (US)

(72) Inventors: Jie Li, Unionville, CT (US); Xiaoguang Sun, West Hartford, CT (US); Paul S Westbrook, Basking Ridge, NJ (US)

(73) Assignee: OFS Fitel, LLC, Norcross, GA (US)

(21) Appl. No.: 18/844,857

(22) PCT Filed: Mar. 3, 2023
(86) PCT No.: PCT/US23/14525

§ 371 Date: Sep. 6, 2024

Related U.S. Application Data
(60) Provisional application No. 63/317,114, filed on Mar. 7, 2022.

(51) Int. Cl. G01D 5/30; G01M 11/00; G02B 6/44

(52) U.S. Cl. CPC G01D 5/30; G01M 11/3109; G02B 6/44715

(57) ABSTRACT

A multicore fiber assembly in which multiple single-mode cores are coupled to form a single path. The assembly reduces the complexity of optical fiber sensor measurement and allows to keep back reflections low and measure various parameters such as fiber twist, temperature, axial strain, and fiber shape.

This application claims the benefit of U.S. provisional patent application Ser. No. 63/317,114, filed Mar. 7, 2022, having the title “SYSTEMS, METHODS AND ASSEMBLIES FOR SINGLE INPUT SHAPE SENSING,” by Jie Li, et al., which is incorporated herein by reference in its entirety.

### TECHNICAL FIELD

The present invention relates generally to the field of fiber optics, and in particular to optical fiber turnarounds for use in fiber-based sensors and like devices. Described herein are systems, methods, and articles of manufacture for shape-sensing using a multicore fiber sensor having at least one single-mode sensing core and can be interrogated through a single optical path that may access all sensing cores with a single measurement.

### BACKGROUND OF THE INVENTION

Optical fibers have been utilized in sensing applications, including measurements of distributed strain and temperature in an optical fiber as well as acoustic signals impinging on the fiber. In one sensing application, an optical signal is transmitted into the optical fiber, and perturbations in the fiber core(s) result in backscatter, which may be analyzed to obtain the shape of the fiber. In another sensing application, the distributed scattering signal provides a measurement of acoustic waves that act to strain the fiber. In such distributed sensors, measurements may be performed at any part of the array. Thus, continuous measurements with specific spatial resolutions are possible along the distributed sensor.

Distributed sensors are optical fiber sensing devices that utilize both single-ended and dual-ended optical fibers as sensors in order to precisely detect and measure temperature, acoustics or strain at selected locations along the length of a well bore or other application in which temperature, acoustics or strain detection over long distances is desired. Dual-ended interrogation (i.e., the ability to launch optical signals into both ends of an optical fiber pathway and to detect the resulting optical signals after transmission) is often preferred for a number of reasons, including improved accuracy, and in order to help compensate for measurement error resulting from exposure and time-dependent hydrogen diffusion and errors associated with splicing and connectors, in the sensor fibers.

The sensing of shape using fibers, such as multicore fibers, as sensors is well known. For instance, it is known that optical fiber shape sensing may use optical frequency domain reflectometry (“OFDR”) measurements of weak distributed reflections from a twisted multicore fiber. Accordingly, one aspect of a conventional optical fiber shape sensing system is the requirement of a multicore optical fiber, wherein all of the cores are offset from the center by a fixed distance. A center core with zero offset from the fiber axis must then be included as a reference to allow for accurate measurement of temperature, axial strain, and/or twist. Each core acts as a local strain sensor and is therefore sensitive to fiber bend and twist when referenced to the center core. Such strain sensing must be performed along multiple paths through the fiber in order to determine the local state of bend and twist along the length of the fiber. Once the local bend and twist have been determined, the shape of the fiber may be computed using differential geometry equations such as, for instance, the FrenetSerret equations.

As a result, back-reflected signals of the OFDR detector must be collected through more than one optical pathway through the fiber. A given core in the optical fiber represents one such pathway. Typically, the signal exiting the distal end of the fiber is scattered or absorbed in a termination so that it does not corrupt the reflected signals from the fiber. Such conventional measurements require a multiplicity of interrogator components or some form of switching to measure all of the cores. For instance, as illustrated in the fiber end view 110 and fiber side view 120 of FIG. 1 (prior art), the input signal may be split into many signals that are directed to each core. The resulting backscatter signal from each core must then be directed to an assortment of detectors in order to obtain signals from each core in the sensor. Such a photonic network can contain many optical components, including couplers, isolators, and polarization beam splitters. Alternatively, as illustrated in the fiber end view 210 and fiber side view 220 of FIG. 2 (prior art), a single source and a single detector may be used with a switch that directs light to different cores sequentially. As a result, the complexity of the interrogator is increased and/or the acquisition speed has decreased from that of a single OFDR measurement. Therefore, there is a need to address more than one sensing core without increasing the complexity and cost of the interrogator.

### SUMMARY OF THE INVENTION

An aspect of the invention is directed to a multicore fiber assembly, comprising a waveguide receiving an input signal from an interrogator via a multicore fanout affixed to a proximal end of the multicore fiber assembly and propagating the input signal in a first direction along a first core of the multicore fiber assembly. The multicore fiber assembly also includes a first turnaround that redirects the input signal at a distal end of the multicore fiber assembly, wherein the waveguide propagates the input signal in a second direction along a second core of the multicore fiber assembly; and a second turnaround redirecting the input signal at the multicore fanout, wherein the waveguide propagates the input signal in the first direction along a third core of the multicore fiber assembly. The first turnaround redirects the input signal, the waveguide propagates the input signal in the second direction along a fourth core of the multicore fiber assembly toward the multicore fanout, and the waveguide propagates a distributed back-reflected signal to the interrogator.

Another aspect of the invention is directed to a optical system for transmitting a single signal in multiple directions within a multicore fiber sensor. The optical system comprising an interrogator; a single core to multicore fanout; a multicore fiber having a proximal end, a distal end, and a plurality of single-mode cores; a GRIN lens affixed to the distal end of the multicore fiber, wherein the GRIN lens has a length of less than 5 mm; and a micro-turnaround affixed to the proximal end of the multicore fiber. The multicore fiber is configured to receive a signal from an interrogator via a multicore fanout affixed to a proximal end of the multicore fiber, propagate the signal in a first direction along at least one core of the multicore fiber, redirect the signal at a GRIN lens affixed to a distal end of the multicore fiber sensor, and propagate a distributed back-reflected signal to the interrogator.

Yet another aspect of the invention is directed to a method of transmitting a single signal in multiple directions within a multicore fiber sensor. The method comprising a) receiving, at the multicore fiber sensor, a signal from an interrogator via a multicore fanout affixed to a proximal end of the multicore fiber sensor; b) propagating the signal in a first direction along a first core of the multicore fiber sensor; c) redirecting the signal at a GRIN lens affixed to a distal end of the multicore fiber sensor, wherein the GRIN has a length of less than 5 mm; d) propagating the signal in a second direction along a second core of the multicore fiber sensor; e) redirecting the signal at a single core turnaround affixed to the multicore fanout; f) propagating the signal in the first direction along a third core of the multicore fiber sensor; g) redirecting the signal at the GRIN lens; h) propagating the signal in the second direction along a fourth core of the multicore fiber sensor toward the multicore fanout; and i) propagating a distributed back-reflected signal to the interrogator.

### BRIEF DESCRIPTION OF THE DRAWINGS

Referring now to the drawings:

FIG. 1 (prior art) illustrates a fiber end view and a fiber side view wherein an input signal may be split into many signals that are directed to each core;

FIG. 2 (prior art) illustrates a fiber end view and a fiber side view wherein a single source and a single detector may be used with a switch that directs light to different cores;

FIG. 3 illustrates one embodiment wherein a fiber with four cores, such that the first pair of cores are offset from the center of the fiber by distance R1 and the second pair of cores are offset by R2 in accordance with one embodiment of the present invention;

FIG. 4 illustrate a fiber and GRIN lens that are coated with a material for absorbing stray reflections in accordance with one embodiment of the present invention;

FIG. 5 illustrates a multicore fiber with perturbations along the entire length of the fiber in accordance with one embodiment of the present invention;

FIG. 6 illustrates a multicore fiber with index perturbations over only a portion of the waveguide in accordance with one embodiment of the present invention;

FIG. 7A illustrates an output being sent through an optical isolator to prevent further back reflections, wherein this may be fed back to the OFDR interrogator and used to reduce phase variations in the interferometric measurements in the OFDR in accordance with one embodiment of the present invention;

FIG. 7B Illustrates how signals can be sent in both directions through four cores of a multicore fiber to enable an interrogation scheme such as BOTDA.

FIG. 8 illustrates a switch to allow measurements in either direction such that signals taken in both directions may improve the accuracy and signal to noise of the sensor in accordance with one embodiment of the present invention;

FIG. 9 illustrates a fiber having a fifth core that is very close to the center of the fiber in accordance with one embodiment of the present invention;

FIG. 10 illustrates the use of a GRIN fiber turnaround at the proximal side of the fiber in accordance with one embodiment of the present invention;

FIG. 11 illustrates an additional core in the multicore fiber that is connected to another interrogator in accordance with one embodiment of the present invention;

FIG. 12 illustrates a multicore fiber containing a multimode core, wherein such a core is used for any number of alternative applications in accordance with one embodiment of the present invention;

FIGS. 13A-C illustrate a variety of intermediate 7-core fibers (a), (b), and (c) in accordance with one embodiment of the present invention;

FIGS. 14A and B shows another embodiment, wherein a bubble or other cavity is etched in the material near the center core at the end of the fiber;

FIGS. 15A-D illustrates a schematic of the experimental setup, wherein a fiber under test (FUT) is a twisted multicore fiber inscribed with continuous weak fiber Bragg gratings in accordance with one embodiment of the present invention;

FIG. 16A-E illustrates an OFDR trace of the shape sensing system, local changes in Bragg wavelength of the four outer cores; and an end face image of FUT with cores labeled in accordance with one embodiment of the present invention; and

FIGS. 17A-C illustrates a reconstruction of FUT under various curvatures with GRIN turn-around device and without the device; as well as a comparison of curvature results for current and previous shape sensing systems in accordance with one embodiment of the present invention; and

FIGS. 18A-E depicts corresponding shape reconstructions of fiber wrapped around two posts at different angles: −90°, −45°, 0°, 45°, and 90° in accordance with one embodiment of the present invention.

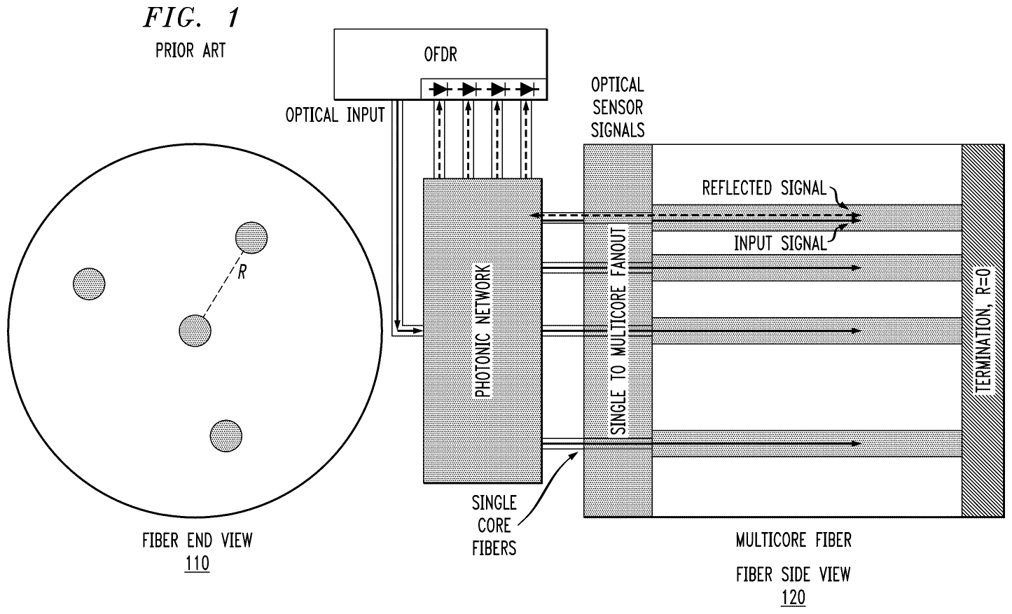

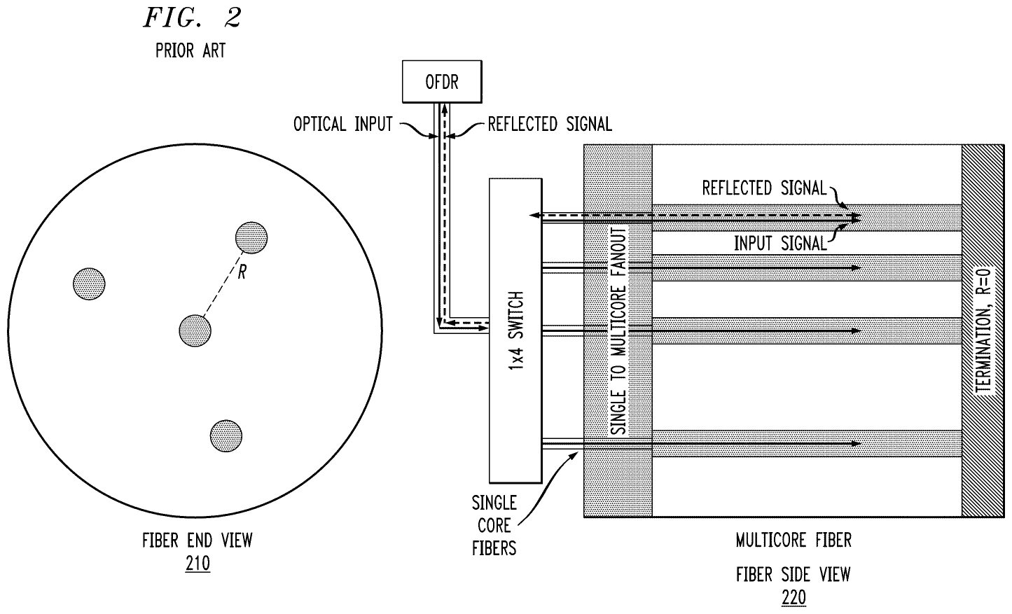

### DETAILED DESCRIPTION

As will be discussed in detail below, the present invention relates to systems, methods and assemblies for single input shape sensing. The exemplary embodiments described herein include a multicore fiber sensor which has at least one single mode sensing core, and which can be interrogated through a single optical path that accesses all sensing cores with a single measurement. Additional embodiments include a multicore fiber sensor that has a graded-index, or “GRIN,” lens fiber turnaround at one or both ends that allows for measurement of more than one core with a single measurement. Accordingly, such a multicore fiber shape sensor may be interrogated using a single optical path from an interrogator.

As noted above, there is a need to address more than one sensing core without increasing the complexity and cost of the interrogator. One method to overcome this limitation involves turning the optical fiber around at the distal end of the sensor. Such a turnaround recycles the input signal from the first core and sends it into a second core. This approach requires the use of a multicore to single-core fanout device, followed by single-core splices from one single-core output to another. In this way, a single measurement can be used to interrogate two cores within a single multicore sensor. Such a multicore fiber turnaround can pose reliability and size issues, though, because the fanout device is bulky, and the fiber turnaround must be larger than a minimum bend radius, typically 5 mm, in order to ensure mechanical stability.

A more compact method of turning the light around in a fiber involves the use of a GRIN fiber spliced at the end of a fiber. Using such a “micro-turnaround,” the light input into one core may be returned in another core using a single, short GRIN assembly spliced onto the end of the fiber, requiring very little extra space. Such micro-turnarounds were applied to fibers with two multimode cores, meant for use in distributed temperature sensing using Raman scattering. However, multimode cores are not suitable for fiber shape sensing due to the many modal pathways within such a core. As a result, such fibers are less suitable for fiber shape sensing. Moreover, fiber shape sensing typically requires measurements from three or more cores, typically including a center core. However, because the GRIN lens must be aligned to the axis of the multicore fiber, the GRIN lens would strongly reflect light from a core on the center axis, thereby corrupting the distributed weak reflections from the other cores.

The exemplary embodiments described herein provide a multicore fiber and turnaround assembly that may couple to multiple single-mode cores through a single path, while keeping back reflections low and allowing for measurements of fiber twist, temperature and axial strain in addition to fiber shape. As will be described in greater detail below, the exemplary method allows for the collection of a signal from a multicore fiber sensor that has at least one single-mode core, using a single optical pathway. This single pathway accesses more than one core and preferably at least four cores. Furthermore, an exemplary multicore fiber shape sensor may be interrogated with a single measurement, and which does not require a bulky turnaround at the far end of the fiber.

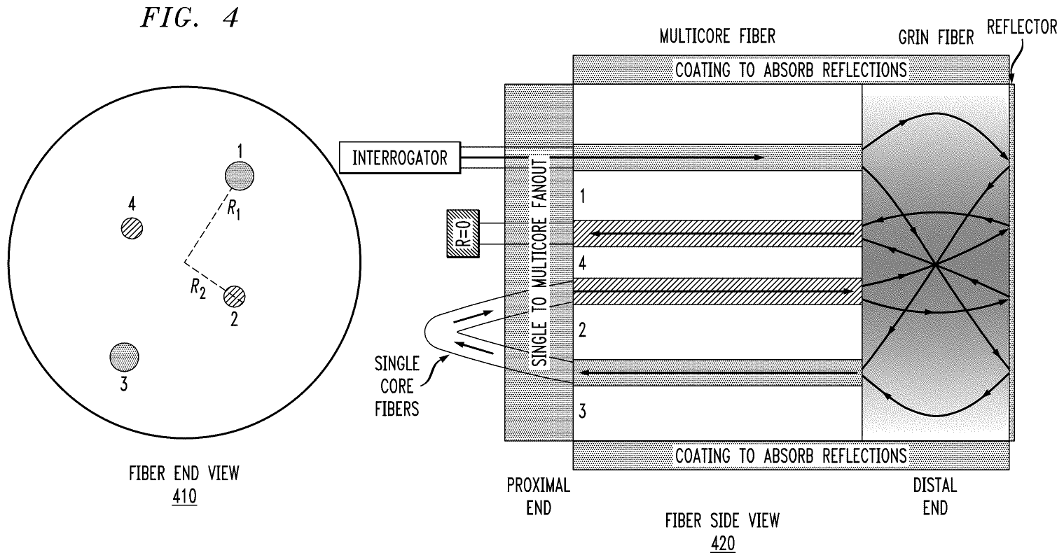

FIG. 3 illustrates a fiber end view 310 and a fiber side view 320 of one embodiment wherein a fiber with four cores is fabricated. Two of the cores are offset from the center of the fiber by distance R1 and a second pair are offset by R2. The lines connecting the pairs may be oriented 90 degrees from each other, or at some other angle. The offset radii R1 and R2 may be the same or preferably, they are different. If they are different, then twist measurement will be possible. It is also possible for the two cores to have different levels of dopants and different dimensions. Possible dopants include Ge, F, B, P, Ce, Sn. For instance, they may have different levels of Ge and F doping, and the cores may have different radii. By this means, properties such as their effective area, effective index and UV photosensitivity may be different. In FIG. 3, two pairs of cores are oriented at 90 degrees with respect to each other, the core radii and doping levels are different and the offset radii are different. They may also be the same. The fiber side view 320 in FIG. 3 shows cores that do not twist around the axis. However, preferably, these cores are twisted along the fiber so as to form four interlocking helices.

While FIG. 3 shows a fiber with only two pairs of cores, it is also possible to have more than two pairs. Thus the fiber may have six cores arranged in pairs centered on the center of the fiber with same offset for each pair. Because there is no core at the center of the fiber, there will be no reflection into the GRIN lens used to turn around the signals at the distal end. FIG. 3 further shows a multicore to single-core fanout device. Such a device may be fabricated by fusing and tapering single-core fibers to a geometry that matches the multicore fiber and then splicing the tapered structure to the multicore fiber.

According to one exemplary embodiment, the single core outputs may be spliced to each other to direct light exiting the multicore fiber back into the multicore fiber. The distal end of the fiber has spliced to it a length of GRIN fiber. Preferably, the center of the GRIN fiber index profile is aligned to the mid point of the pairs of cores 1 and 3, and 2 and 4. The GRIN fiber length is adjusted so that light exiting one of the two pairs of cores is reflected back into the other member of the pair of cores. Typically, a reflective film is added to the GRIN fiber end face to maximize the reflection. In this way, back reflected light scattered from both of the cores can be collected with a single measurement.

As illustrated in a fiber end view 410 and a fiber side view 420 of FIG. 4, the fiber and GRIN lens are preferably coated with a material that absorbs stray reflections. This material may be a polymer whose refractive index is larger than the fiber refractive index. It may also exhibit very high attenuation at the wavelengths used by the interrogator. FIG. 3 shows how the light can traverse all of the cores. Light leaves the interrogator (which can be an OFDR) and goes to a single core to multicore fanout which sends the light into core 1 of the multicore fiber. The GRIN fiber sends this signal back into core 3 at the distal end of the fiber. When the light returns to the proximal end where the fanout is located, the light from core 3 goes into the single core fiber corresponding to core 3. This fiber is spliced onto the single core fiber connected to core 2 in the multicore fanout. The light in core 2 then propagates to the GRIN fiber at the distal end where it is turned around again and sent into core 4. When the light arrives at the fanout and goes into the single mode fiber corresponding to core 4, it may be terminated for low reflection with index matching gel. Such low reflection terminations are required for interrogation methods such as OFDR.

FIG. 3 shows the input interrogator signal as a solid line. It also shows a portion of the distributed back reflection signal as a dashed line. While FIG. 3 shows only one point of reflection returning to the interrogator, it is understood that a distributed reflection will return from all portions of the waveguides.

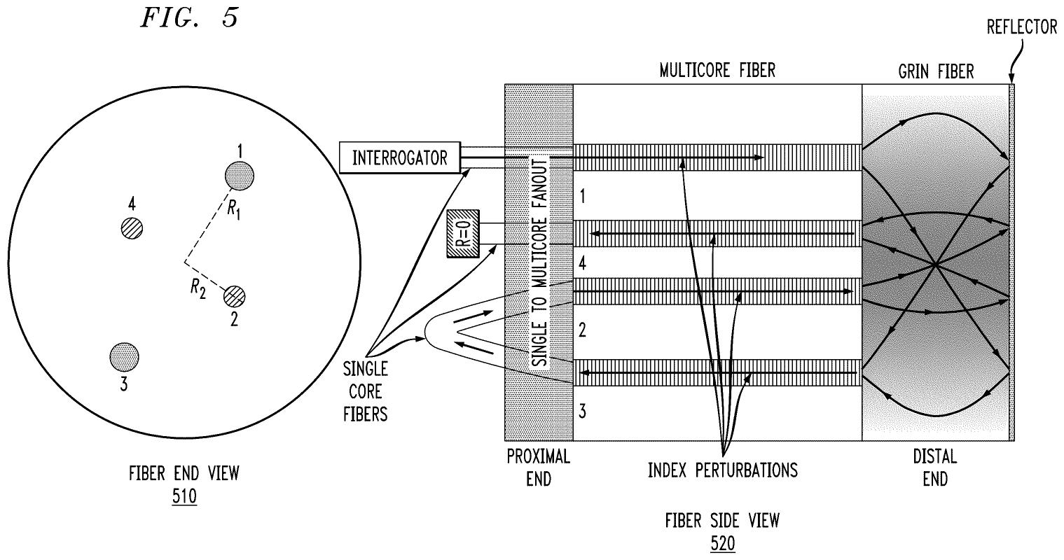

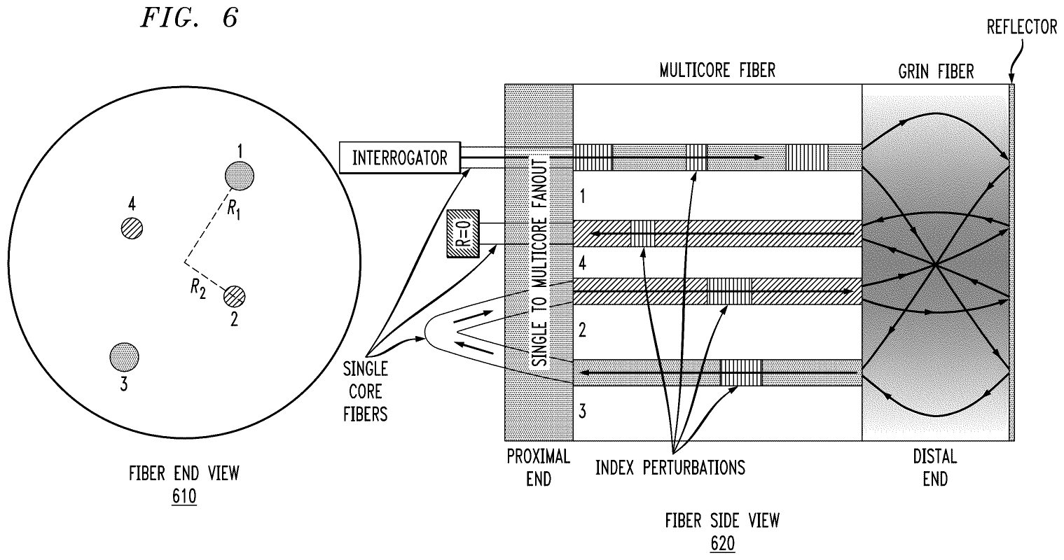

It is also possible to modify the cores in the multicore fiber by introducing index perturbations along their length. Such perturbations may be used to increase the back reflected signal. Such perturbations may be periodic, chirped, or aperiodic. A fiber end view 510 and a fiber side view 520 of FIG. 5 show a multicore fiber with perturbations along the entire length of the fiber. Alternatively, a fiber end view 610 and a fiber side view 620 of FIG. 6 show a multicore fiber with index perturbations over only a portion of the waveguide. The strength of the index perturbations may be different in different waveguides. For instance, if the Ge doping in core 4 of FIG. 5 is larger than that of core 1, then the index perturbations in this waveguide will be larger when they are introduced through actinic radiation. Furthermore, UV irradiation through a phase mask of a given period will inscribe Bragg gratings in all cores. If a given core has more Ge then it will exhibit a grating with a larger reflection, since UV photosensitivity depends on the level of Ge doping. Such a larger reflection can counteract an attenuation that may occur as the input light propagates through the cores.

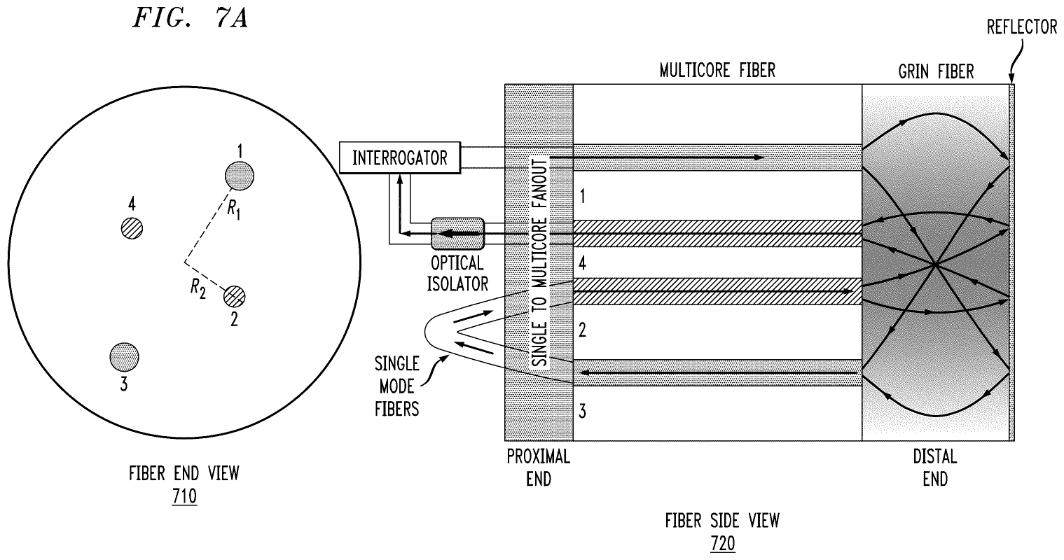

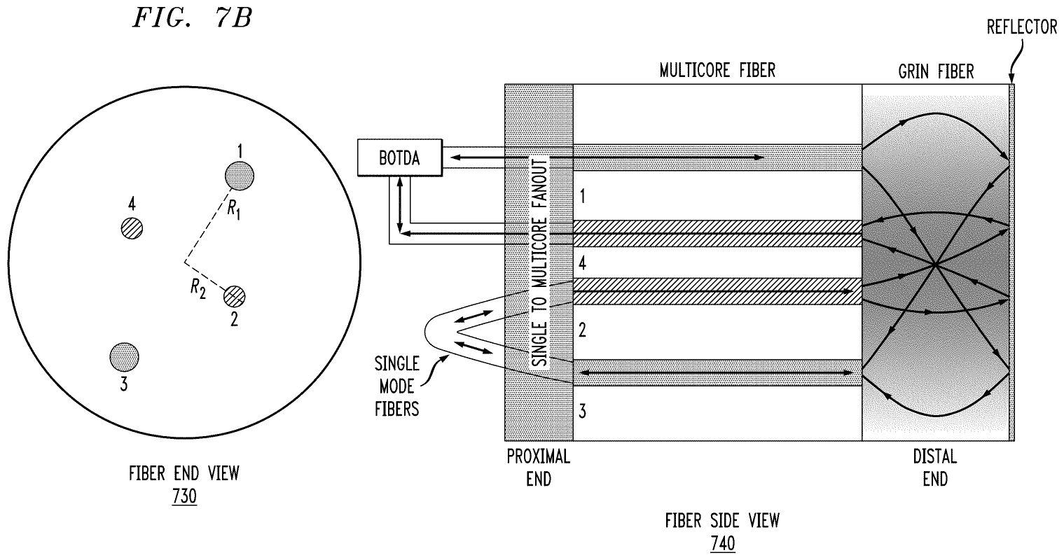

It is noted that the signal exiting core 4 may also be used for other sensing tasks. As shown in a fiber end view 710 and a fiber side view 720 of FIG. 7A, this output may be sent through an optical isolator to prevent further back reflections. This signal may be fed back to the OFDR interrogator and used to reduce phase variations in the interferometric measurements in the OFDR. For instance, a phase disturbance in the multicore fiber can be observed in the transmitted signal and used to correct phase variations in the reflected signals. In one embodiment, the transmitted signal may be used as the local oscillator in the OFDR measurement. The signal exiting core 4 may also be sent to another interrogator such as an optical spectrum analyzer to monitor the change of spectrum through the sensor fiber. When both ends of the optical path are accessible, it is also possible send a signal into the fiber in the reverse direction. Thus, although FIG. 7 shows a signal propagating in only one direction, it is also possible for the interrogator to send signals in both directions through the multicore fiber. These signals may be sent simultaneously. In one embodiment the simultaneous counter propagating signals may be interfered within the interrogator to produce a sensing output.

In another embodiment, the interrogator may be a Brillouin Optical Time Domain Analysis (BOTDA) interrogator. Such an interrogator requires propagation of signals in both directions of the fiber cores in order to achieve improved spatial resolution using Brillouin scattering. A fiber end view 730 and a fiber side view 740 of FIG. 7B show how a BOTDA interrogator may be used to send signals in both directions in all four cores of the sensing fiber. Arrows going in both directions indicate that the BOTDA signals are propagating in both directions in all four cores of the fiber side view 740 of FIG. 7B. Other interrogators that require access to both ends of the fiber may also be used instead of the BOTDA.

Instead of a BOTDA, the interrogation scheme may be Brillouin optical correlation-domainanalysis (BOCDA). BOCDA also requires signals from both directions of the fiber.

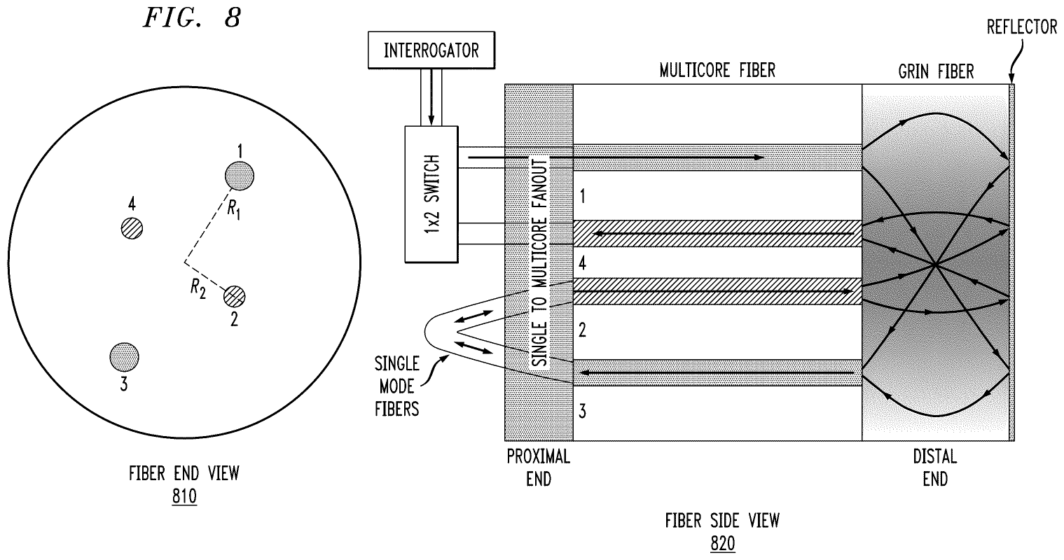

As shown in a fiber end view 810 and a fiber side view 820 of FIG. 8, one embodiment may include a switch to allow measurements in either direction such that signals taken in both directions may improve the accuracy and signal to noise of the sensor. In another embodiment, a pump signal may be propagated in cores in order to amplify the signal. The amplification may arise from mechanisms such as rare earth ion dopants, such as Er or Yb, or through Raman or Brillouin gain. In another embodiment the two ends of the optical path may be combined in an interferometer. The beat signal between the two paths can be used to sense rotations and other changes in the fiber.

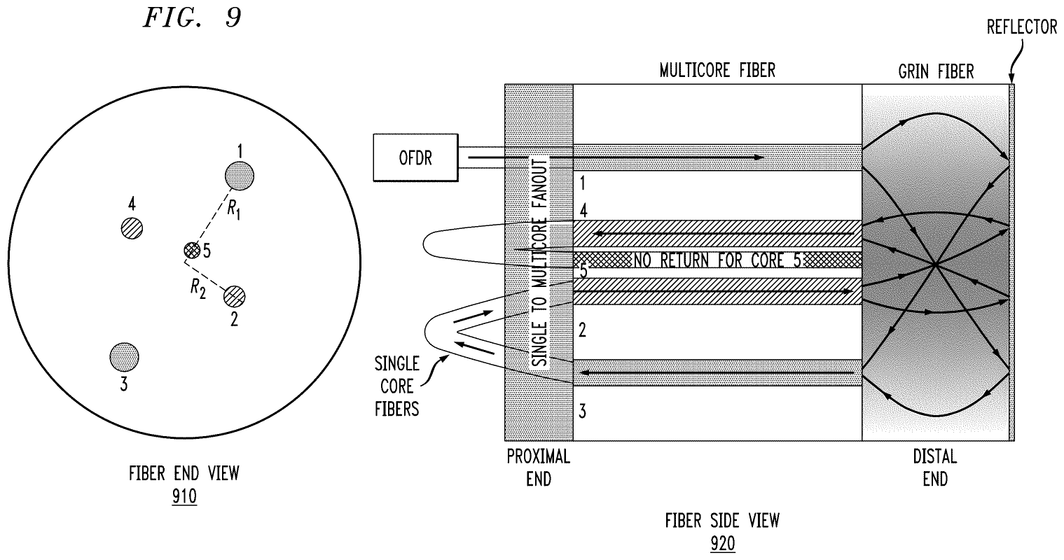

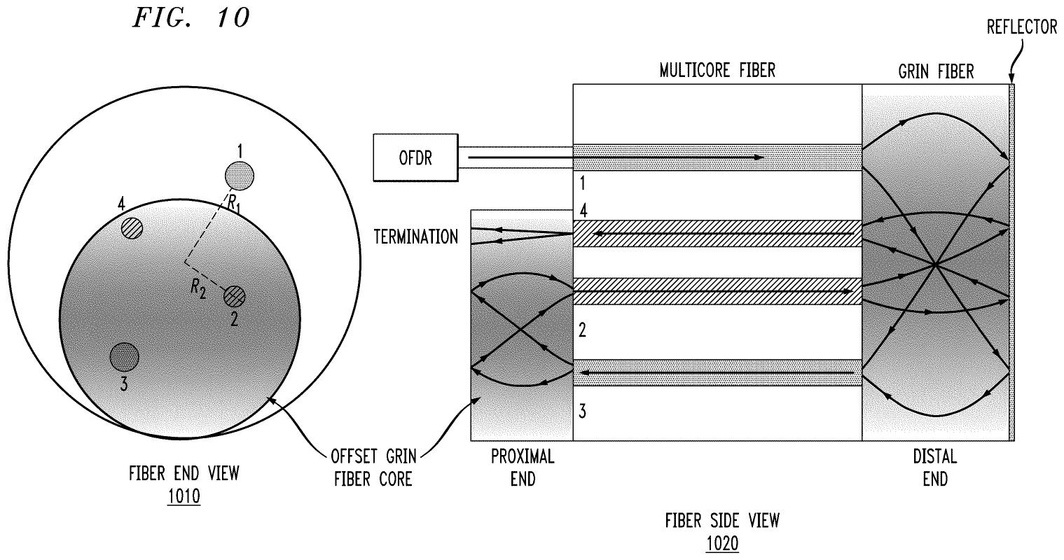

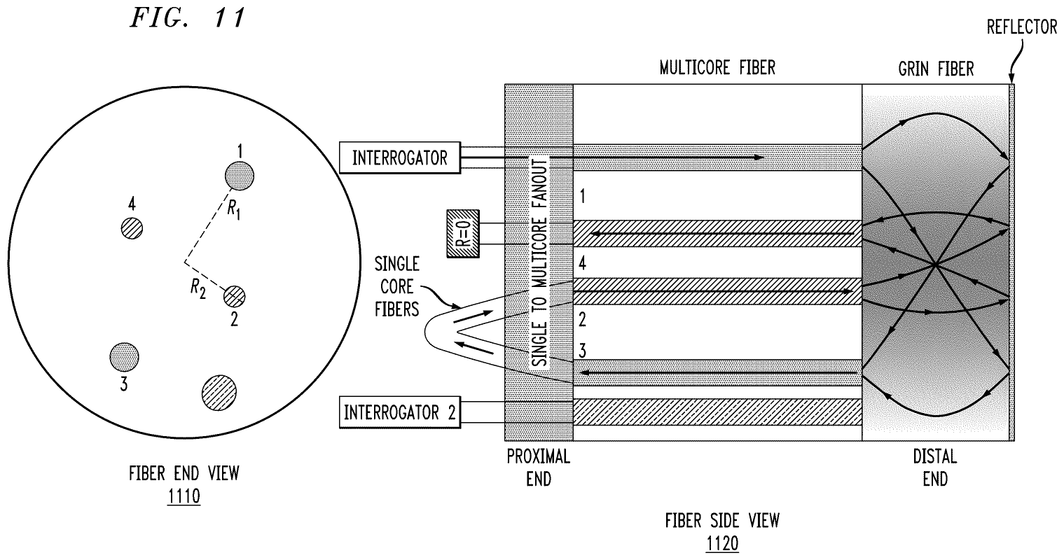

A fiber end view 910 and a fiber side view 920 of FIG. 9 illustrate a fiber having a similar design to that of FIG. 3. However, a fifth core is included that is very close to the center of the fiber. The light returning to the fanout for the second time through core 4 is sent back into the nearly centered core 5. This core will allow for a better separation of bend, twist and axial strain since it is very close to the center of the fiber where only axial strain and temperature affect the fiber core. Unlike the other cores of the fiber, when light from this core enters into the GRIN fiber, the back-reflected light is directed into the non-guiding cladding of the fiber. As a result, there is no back-reflection from this core and it is therefore optically terminated.

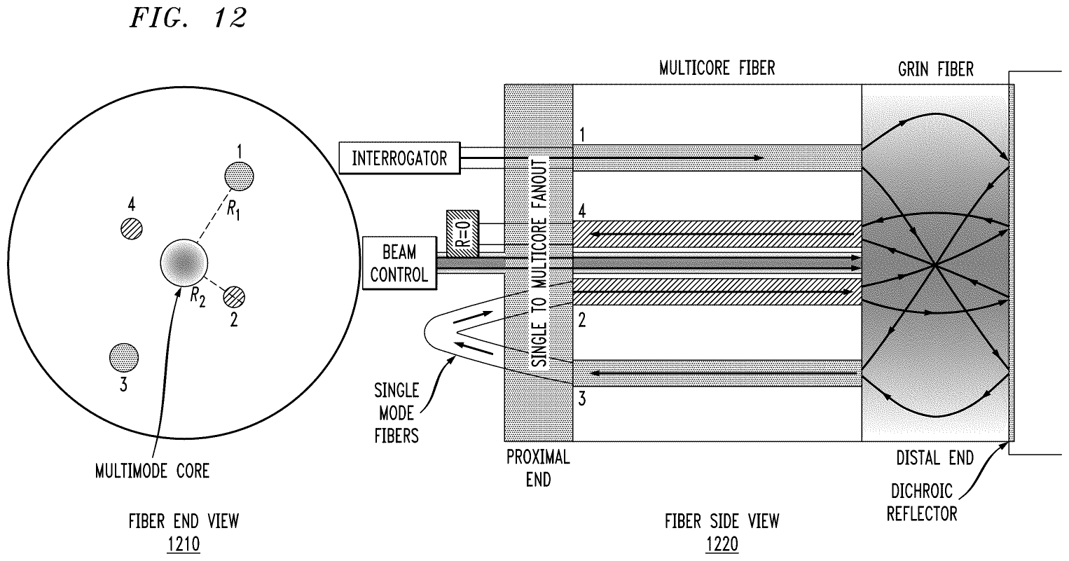

A fiber end view 1010 and a fiber side view 1020 of FIG. 10 show the use of a GRIN fiber turnaround at the proximal side of the fiber. Specifically, FIG. 10 shows how an offset GRIN fiber core can send light from one core to another while allowing for an input fiber to connect to one of the other offset cores. The fourth core does not reflect back into the fiber and is thus terminated.

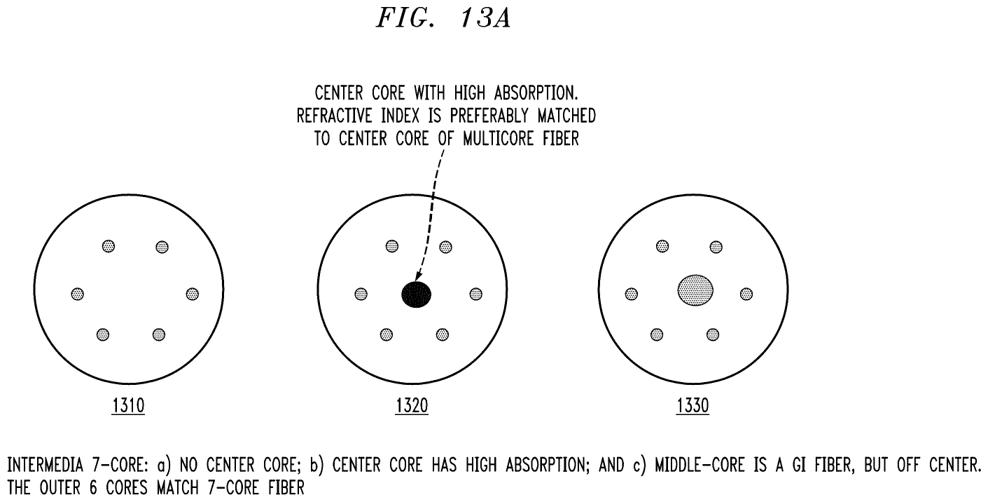

As shown in a fiber end view 1110 and a fiber side view 1120 of FIG. 11, an additional core is present in the multicore fiber, wherein the additional core may be connected to another interrogator. For instance, this core may have Bragg gratings inscribed at various locations in order to measure local strain. Alternatively, this additional core may allow for temperature measurement along the fiber.

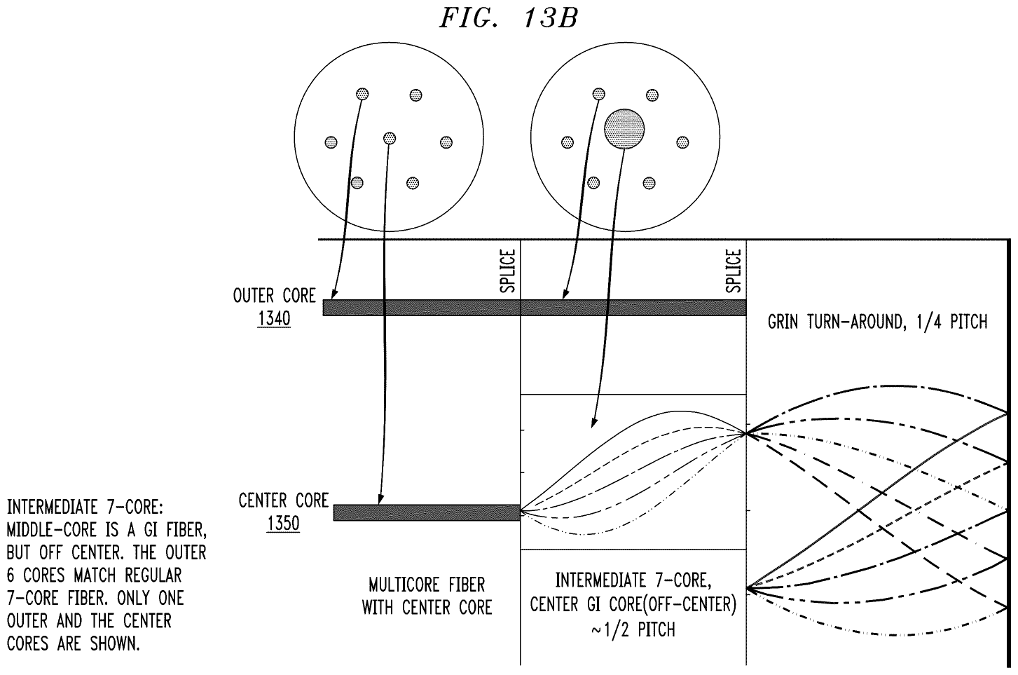

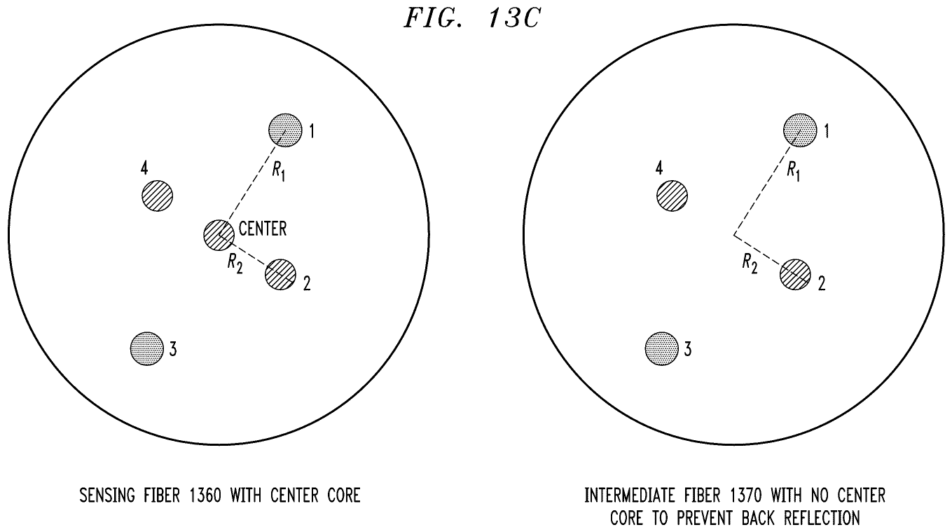

In a further embodiment, a fiber end view 1210 and a fiber side view 1220 of FIG. 12 show a multicore fiber which contains a multimode core, wherein such a core is used for any number of alternative applications, such as, but not limited to, imaging, to carry telecommunications signals, the delivery of high power radiation, etc. The fanout device couples an input single core multimode fiber to this multimode core. In the embodiment, a beam control or alternatively a mode control device such as a Spatial Light Modulator (SLM) or Digital Mirror Device (DMD) is used to launch light into this multimode core. A calibration of the multimode core determines the precise launch conditions to produce a given image or spot on the distal end of the fiber. Importantly, the reflector at the distal end is dichroic. This means that the reflector is highly reflecting for the sensing light in all of the cores whose signals are turned around. However, the light propagating in the multimode waveguide has a wavelength that passes through the reflector forming a spot or other pattern on the other side of the GRIN fiber. The reflector may pass all of the imaging light or only a fraction. In one embodiment, the sensing light has a vacuum wavelength in the range from 1500 nm to 1650 nm. In another embodiment, the imaging light has a vacuum wavelength in the visible region of the optical spectrum. In another embodiment, the transmitted light has a wavelength between 1000 nm and 1150 nm. In another embodiment the transmitted light carries telecommunications signals.

In a preferred embodiment, the other cores of the multicore fiber are used to determine the shape of the fiber and this shape is used to determine the required launch into the multimode fiber so that a desired output forms at the distal end beyond the GRIN fiber.

It is also possible for the multimode waveguide to overlap one or more of the single mode waveguides.

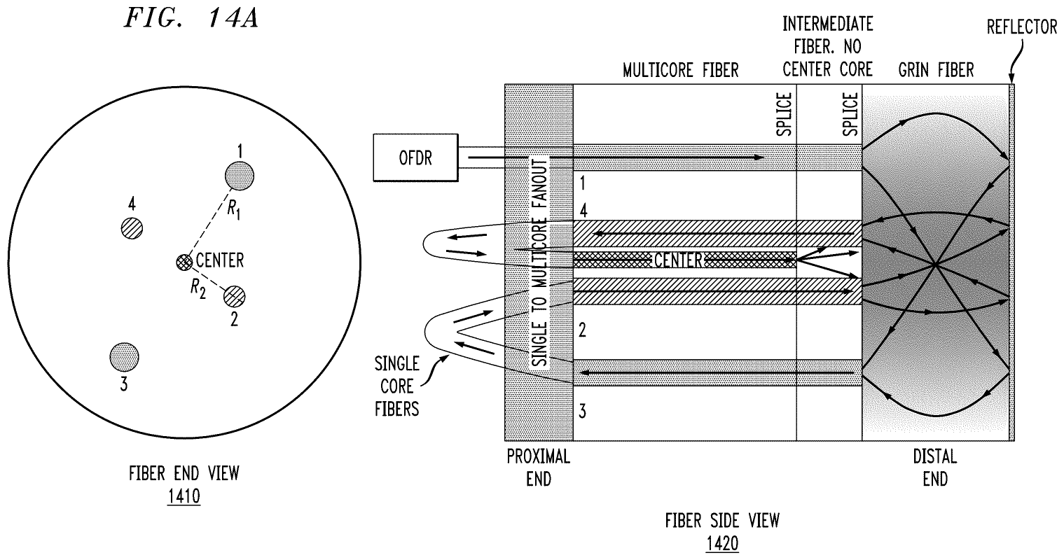

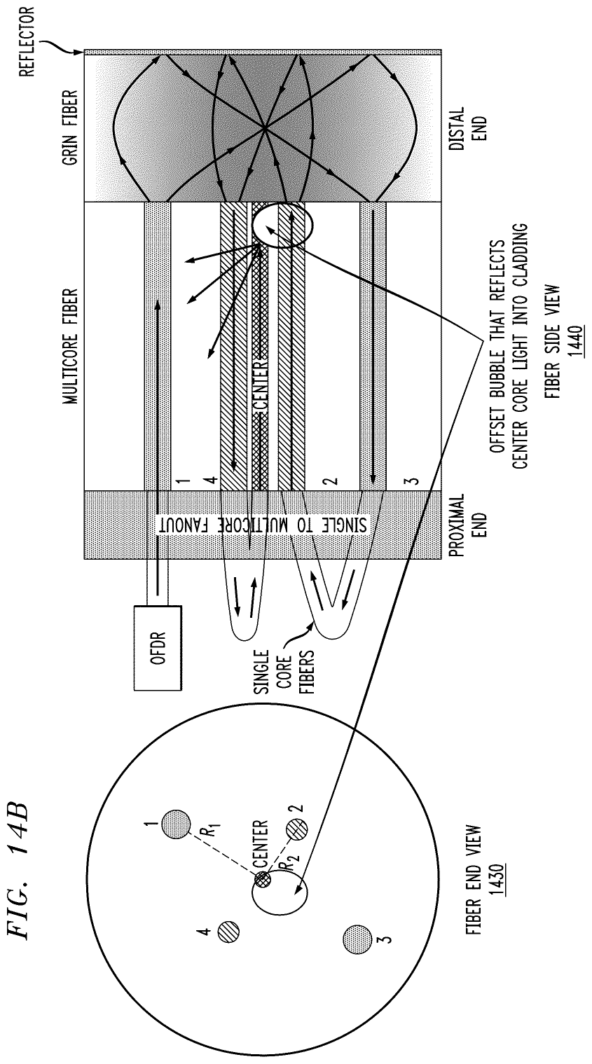

If the center core is needed and the back reflection from the turn-around must be minimized, an additional intermediate fiber can be added between the sensing fiber and the GRIN turn-around to reduce the back-reflection from the GRIN turn-around. The outer cores of the intermediate fiber have the same structures (locations, mode field diameter (“MFD”), numerical aperture “NA,” etc.) of the outer cores of the sensing fiber. The center core of the intermediate fiber can be absent, or it can have high absorption (preferably refractive index is matched to center core of the multicore fiber) or it can be an off-centered graded-index fiber shown in various configurations (1310, 1320, and 1330) illustrated in FIG. 13A. In all cases it is preferable if the center of the intermediate fiber has a refractive index that is similar to or the same as the center core of the multicore fiber. High absorption may be achieved with dopants such as cobalt. In this way, the reflectivity due to refractive index mismatch will be reduced. High attenuation may be achieved in other ways. For instance, a tilted grating may be inscribed in the center core that scatters all incoming light to the cladding or to free space modes. In FIG. 13B the intermediate fiber 1370 is shown spliced to the multicore sensor fiber 1360 and then spliced to the GRIN turnaround fiber. The intermediate fiber 1370 is seven-core fiber with a middle-core being a GI fiber, but of-centered, and the outer six cores match to the cores of the multicore sensor fiber 1360. Only the center cores 1350 and one outer core 1340 are shown. The length of the intermediate fiber 1370 is chosen to minimize the back reflection into the center core 1350 and all of the other cores 1340 of the multicore fiber. In FIG. 13B this length is chosen to be one half of the pitch in the offset Graded Index (GI) core. In this way the output light will be focused away from the center of the multicore fiber. FIG. 13C shows the cores for another design. The sensing multicore fiber 1380 has a guiding center core. The intermediate fiber 1390 has no center core to prevent back reflection. Equivalently, the intermediate fiber 1370 could have a very lossy center core, preferably index matched to the sensor fiber center core, or it could have an offset multimode core. Moreover the radii R1 and R2 could be different or they could be the same. Finally, there could be more or less than 5 cores in the sensing fiber. FIG. 14A shows the side view of the fiber assembly. It shows the single core to multicore fanout connected to a 5 core fiber, which is spliced to an intermediate fiber 1390 with no center core, and then spliced to the GRIN fiber. Light reflection from the end of the center core at the splice to the intermediate fiber is minimized. This light is shown escaping into the intermediate fiber 1390 where it will spread out and get absorbed in the coating and have minimal power back scattering into the center core. The length of the intermediate fiber 1390 is chosen to reduce this back reflection.

A fiber end view 1410 and a fiber side view 1420 of FIG. 14A and a fiber end view 1430 and a fiber side view 1440 of FIG. 14B show other embodiments. In this embodiment, a bubble or other cavity is etched in the material near the center core at the end of the fiber. In one embodiment, such a bubble may be etched into a silica waveguide using an intense pulse of light from a femtosecond laser. The intense pulse may be introduced from the side of the fiber or along the axis of the fiber or at an angle with respect to the fiber axis. Preferably, the bubble or etched region is offset from the center of the fiber but overlapping with the center core of the fiber. Preferably the bubble or etched cavity does not overlap any of the other cores as indicated in the fiber end view 1430 in FIG. 14B. If the cavity is formed before the splice to the GRIN fiber, then the cavity must survive the splicing procedure that attaches the GRIN fiber to the end of the multicore fiber. The effect of the bubble or cavity is to reflect all light incident on it from the center core out of the fiber. This can be most effective if the angle or angles of the wall of the bubble or cavity with respect to the fiber axis is larger than the critical angle for total internal reflection for the guided light in the center core. In this way, there will be no light reflected from the center core back into the center core.

Exemplary embodiments described herein allow for the reduction of unwanted reflections at the interface between the multicore fiber and the GRIN lens fiber. Unwanted reflections arise from the discontinuity in the waveguides. This discontinuity can result in a back reflection and it can also result in scattering of light out of the GRIN fiber. For instance, if the multicore fiber has single-mode offset cores, then, it should have an effective index that matches or is less than the level of the GRIN fiber index at the radius at which the offset core is spliced onto the GRIN fiber. In this way, the back reflection at the interface will be reduced, and the GRIN fiber will be able to guide the light that exits from this single-mode fiber into the GRIN without waveguide loss.

It is noted that the GRIN fiber and the sensor fiber have a coating that absorbs stray light so that this light is not reflected into the OFDR. Such stray reflections cause spurious signals and must be reduced for the OFDR to achieve maximum accuracy.

The exemplary embodiments described herein take different approaches to shape sensor interrogation that measures fiber shape with a single high-performance OFDR measurement. For instance, a twisted multicore fiber may be combined with a GRIN lens turn-around on the distal side of the fiber and splicing on the proximal multicore fanout in such a way that a single input signal from the OFDR can provide back-reflected sensor signal from four cores. At the distal side of the fiber, the GRIN lens turn-around reflects light from one of the cores to a core with the same radial offset and 180° from the first core. At the fanout the returned light is spliced to a core that is 60° from the first core and this light is then reflected to the next core. This embodiment demonstrates that the back reflected light from these four cores can be used effectively in shape sensing. Compared to the performance of a single-ended shape sensor using a 1×4 switch to obtain the signals from each core, similar performances were found. The single-ended shape sensor fiber may also be wrapped around two posts and reconstruct this wrapping shape as the posts were rotated with respect to each other. It is expected that a single-ended shape sensor may find use in applications that require a compact distal fiber end and where demands of cost and/or performance require the use of a single channel OFDR system.

Distributed optical fiber sensors have been shown to be an invaluable tool in many applications—such as structural health monitoring, acoustic wave sensing, and in biomedical applications—because of their accuracy, sensitivity, flexibility, and immunity to EM interference. One of the most demanding sensing applications is shape sensing or fiber shape reconstruction. Optical fiber shape sensing refers to many different applications, from monitoring of large structures such as airplane wings, wind turbines, and bridges, with single core fibers bonded to the structure, to the deflection small objects such as of needles, catheters, and other surgical tools using multicore fiber. Typically, these sensors use wavelength division multiplexed (WDM) fiber Bragg grating arrays that are interrogated by measuring the optical reflection spectrum of each individual grating. However, WDM Bragg gratings measure strain only at discrete locations and such sensors are typically limited to less than 100 sensing points and spatial resolution greater than 1 mm. Another method of fiber shape sensing employs Brillouin scattering to measure distributed fiber strain in multicore and single core fibers. While such schemes can be applied over long lengths, they have spatial resolution on the order of centimeters. Moreover, both the proximal and distal ends of the fiber must be accessible for the sensor to be interrogated.

For more accurate shape reconstructions, measurement of fiber strain with spatial resolution less than 1 mm is required. To date, such high spatial resolution can only be achieved using swept wavelength interferometry (SWI), alternatively known as Optical Frequency Domain Reflectometry (OFDR). In OFDR, spatial resolution is governed by the wavelength scan range, and maximum measurable fiber length is determined by the wavelength step size. The spatial resolution can be less than 100 μm and fibers over tens of meters can be measured. Strain and shape sensing have been shown by using the discrete Bragg gratings or Rayleigh scatter with OFDR. Although sensing with Rayleigh scattering is distributed along the fiber and therefore provides high spatial resolution, this backscattered signal is very weak and exhibits a randomly varying phase, which limits interrogator speed and stability. Efforts to improve the backscatter by using UV enhanced fiber have been shown, but this fiber still displays an uncontrolled phase. A significant improvement in both signal noise and phase information was demonstrated using nearly continuous arrays of weak uniform period gratings written into multicore fibers. Moreover, the outer cores in these waveguides were spun during draw so that they formed helices around the center core. Such quasi-continuous gratings in twisted multicore fibers have greatly improved the accuracy and speed of fiber shape reconstruction using OFDR. These fibers have enabled OFDR interrogation to be used in applications such as medical shape sensing and sensing micron sized deformations along a fiber.

Compared to other methods, OFDR requires a more complicated interrogator, which uses a precisely tuned narrow linewidth source and phase sensitive measurements. Applying OFDR to four separate channels for shape sensing adds yet more complexity. Typically, this requires an optical switch to measure the different cores in succession, which can degrade the signal quality in dynamic environments. Alternatively, an input/output network can be used to distribute the input signals to the four cores and collect the back reflected signal from each core. To obtain simultaneous measurements, such schemes would require four separate detector modules. This additional complexity brings increased cost, and can compromise accuracy, speed, and stability.

The exemplary embodiments described herein take a different approach to shape sensor interrogation that requires only a single high spatial resolution OFDR measurement while still maintaining a compact distal fiber end compatible for use in medical catheters and other compact applications. For instance, a 498 μm long graded index (GRIN) fiber lens may be spliced to the distal end of a twisted multicore core fiber to reflect light from a given outer core to the second opposite core 180 degrees away. In this way, both the input light and the distributed backscattered light used in the OFDR interrogator follow a path forward and backward through the multicore fiber. It is noted that an exemplary GRIN fiber lens may be less than 5 mm in length, preferably less than 1 mm or less than 500 μm.

At the proximal fanout, the single core fiber output of the GRIN lens reflected signal may be spliced to another single core fiber that connects to the third outer core. The light entering this core is then reflected by the same GRIN lens back into a fourth core. Accordingly, it is shown that the back-reflected light from these four cores can be used effectively in bend and shape sensing with 80 μm spatial resolution. Furthermore, when comparing the performance of the exemplary single measurement micro-turnaround shape sensor with a 1×4 optical switch system that interrogates each core sequentially, similar performance was found for a range of curvatures from 2.2 m⁻¹ to 52 m⁻¹. Furthermore, shape reconstruction may be performed with the exemplary shape sensor fiber wrapped around two posts that were rotated with respect to each other. The reconstructed fiber shapes showed good agreements with experimental results. It is expected that the exemplary micro-turnaround shape sensor will find use in applications that require a compact distal fiber end and where demands of cost and/or performance require the use of a single channel OFDR system.

### Sensor and GRIN Design

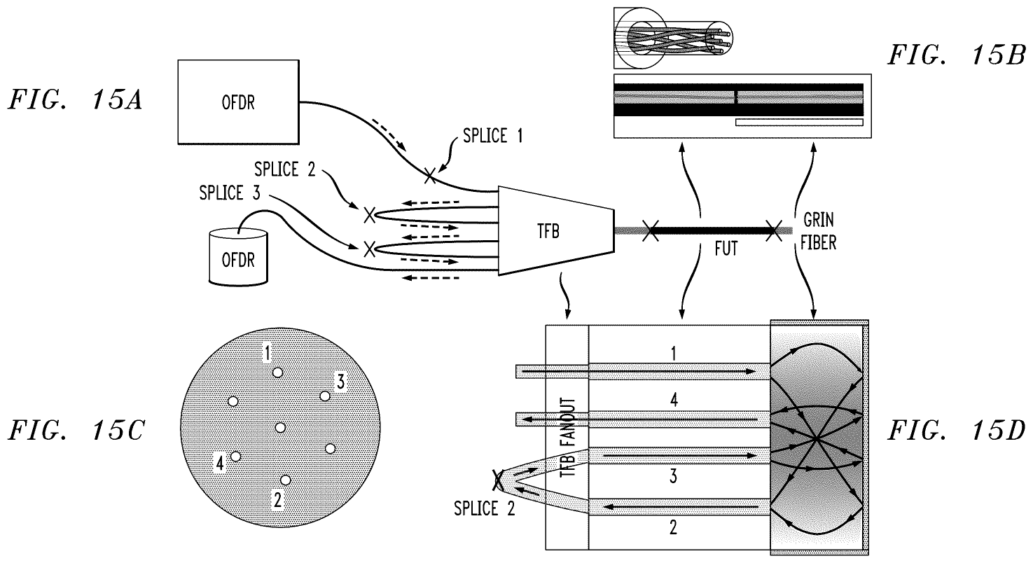

FIGS. 15A-D illustrate a schematic of the experimental setup, wherein a fiber under test (FUT) is a twisted multicore fiber inscribed with continuous weak fiber Bragg gratings in accordance with one embodiment of the present invention. FIG. 15A shows an experimental setup including an OFDR (optical frequency domain reflectometer), a TFB (tapered fiber bundle), and a FUT (fiber under test). FIG. 15B shows a diagram of the twisted multicore fiber with continuous gratings. FIG. 15B also shows a side image of GRIN fiber spliced to the FUT before a metal coating is applied. FIG. 15C shows an end face image of FUT. FIG. 15D shows a ray-tracing diagram of the FUT and turnaround device. For clarity, only the first four cores are shown and the twist of the FUT is not shown. Accordingly, alternative and/or additional embodiments may feature any number of cores and may or may not feature a twist.

The fiber has one center core and six outer cores, the end face image is shown in FIG. 15D. The outer cores are 35 μm from the center core and are twisted along the length of the fiber with a period of 2 cm (or 50 twists per meter). In order to inscribe long lengths of continuous FBGs and maintain fiber mechanical strength, the fiber is coated with a UV transparent coating. The FBGs are inscribed with a 248 nm excimer laser through a phase mask technique to give a Bragg wavelength of ˜1541 nm.

While conventional applications of GRIN lenses and fibers may refocus a point source of light, the exemplary embodiments of this invention exploit this effect to allow the OFDR to measure backscatter signals from all outer cores of the fiber. To interrogate the outer cores of the FUT serially, the proximal end of the fiber is spliced to a tapered fiber bundle (TFB) multicore to single core fanout that has seven single core fiber inputs and one multicore fiber output. The distal end is spliced to the GRIN turnaround device. A sideview image of the FUT spliced to the GRIN fiber is shown in FIG. 15B. The GRIN fiber has a length of 498 μm, core diameter of a=115.3 μm, cladding diameter of 127 μm, and core index profile of

$$n ( r ) = {n}_{0} ( 1 - \frac{{g}^{2}}{2} {r}^{2} ) ,$$

where n₀=1.4687 and

$$g = \frac{NA}{{an}_{0}} = 0.003153 ( \frac{1}{μ m} )$$

$$and$$

$$NA = 0. 2663 .$$

In such a fiber, a focused spot will refocus after a length P=π/g and therefore if the GRIN has a length of

$$\frac{π}{2 g} = 498$$

μm the light will expand, reflect off the end of the fiber and refocus into an opposite core. After splicing to the shape sensor fiber, the GRIN lens and shape sensor fiber were dipped in a reflective silver coating, up to about 15 mm from the end of the GRIN lens. As shown schematically in FIG. 15D, the GRIN fiber can focus light from one of the offset cores to another offset core that is at the same radius but rotated 180° from the first core. To access offset cores that are less than 180° degrees from Core 1, the fanout single core output from Core 2 was spliced to Core 3, which is 120° from Core 2. Note that Core 3 is arbitrarily chosen and can be the core 60° from Core 2 as well. In the current experiment, Core 4 was also spliced to Core 5 and 6, but these cores were left out of the analysis for reasons listed below.

### OFDR and Data Processing

The distributed strain may be measured along the fiber sensor using OFDR. This technique is well known and has been used to measure discrete attenuations, strain and temperature in optical fibers. Briefly, the OFDR technique sends a narrow linewidth signal into the fiber to be measured. The weak, distributed back reflection from the entire fiber length is interfered with a reference beam from the same laser. As the laser is scanned over a given range of frequencies, a spectral interferogram R(ω) is recorded in which every position on the fiber is represented by a spectral oscillation frequency. A Fourier transform of this spectral interference results in a time domain quantity:

$$F T \{ R ( ω ) \} = {R}_{OFDR} ( t ) {e}^{i {ϕ}_{OFDR} ( t )} \# \qquad ( 1 )$$

where FT represents Fourier Transform with amplitude R_{OFDR} (t) and phase ϕ_{OFDR} (t). Time may be related to position along the fiber through z=v_{group}t, where v_{group} is the group velocity. R_{OFDR} (t) is simply the magnitude of the reflection at a given point. The spatial phase ϕ_{OFDR} (t) gives rise to the sensing signal through the time (or spatial) derivative:

$$\frac{d {ϕ}_{OFDR} ( t )}{dt} = {ω}_{Bragg} ( t ) = \frac{2 π c}{{λ}_{Bragg} ( \frac{z}{{v}_{group}} )} \# \qquad ( 2 )$$

Here the phase derivative is related to a vacuum Bragg wavelength that varies along the optical fiber. This local effective Bragg wavelength depends on the local strain and temperature of the fiber in the same way that a discrete fiber Bragg grating would. In our fiber, the presence of a weak quasi-uniform periodic modulation along the fiber results in a large value of R_{OFDR} (t) and a very well-defined value of ϕ_{OFDR} (t) and hence,

$${λ}_{Bragg} ( \frac{z}{{v}_{group}} ) .$$

The weak gratings thus greatly simplifying the measurement over similar measurements that rely on Rayleigh backscattering.

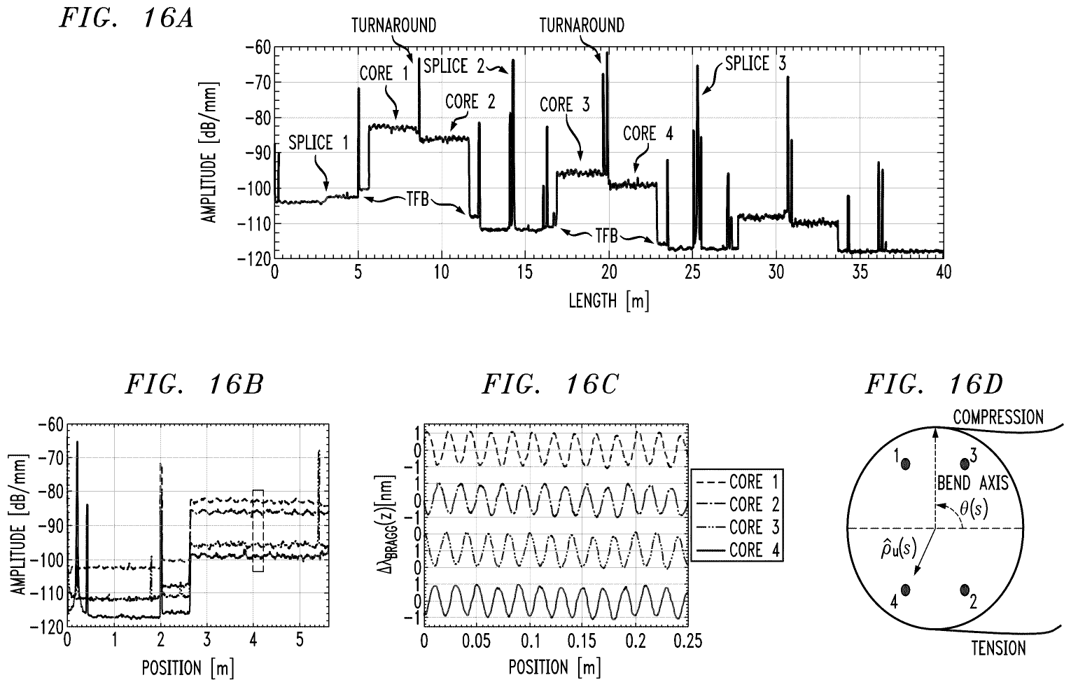

FIGS. 16A-D illustrate an OFDR trace (FIG. 16A) of the shape sensing system, cropped and flipped amplitudes of the four outer cores (FIG. 16B), local changes in Bragg wavelength of the four outer cores (FIG. 16C); and the geometry of a fiber cross section (FIG. 16D) of FUT with cores labeled. An OFDR trace of R_{OFDR} (Z) for our system is shown in FIG. 16A. The y-axis units are power in dB/mm (20 log₁₀ R_{OFDR}) normalized to a 1 mm length. The OFDR trace shows back reflection from six transits through the six outer cores of the fiber, alternating between forward and backward direction of light propagation. The output of the OFDR is spliced into the TFB fanout fiber corresponding to Core 1 of the FUT (Splice 1). A small increase in backscattered signal is observed at Splice 1 because of the difference in Rayleigh scattering between the output fiber of the OFDR (SMF-28) and the TFB fanout fiber. The large spike in the OFDR trace after the input splice is caused by the TFB itself. The enhanced backscattered signal of the FUT from the continuous gratings is clearly seen (Core 1). The GRIN turnaround device, spliced to the distal end of the FUT, appears as a spike, followed by a drop in signal due to attenuation and reflection loss. We note that there was another FUT-to-FUT splice near the GRIN lens splice. The signal is then spatially reversed with respect to the signal from Core 1 and propagates toward the fanout at the proximal end of the FUT (Core 2). The output of the Core 2 fanout is spliced to the Core 3 fiber of the fanout. Signal in Core 3 and Core 4 will also propagate in a similar fashion as Core 1 and Core 2, although with lower amplitude due to losses in the TFB and multicore splices. Core 5 and Core 6 were also spliced into the signal path and their OFDR signals can be seen as well. However, they were not used in this set of experiments because the signal degraded too much due to losses in the system. Most of this attenuation is due to the TFB and two unoptimized multicore fiber splices rather than the GRIN lens turnaround. Each GRIN reflection, including the splice to the multicore fiber, has a roundtrip loss of ˜2 dB. The other losses are estimated as follows: each one-way pass between the TFB multicore output-to-FUT splice has a loss ranging from 1.6 to 3 dB, the TFB itself has a 3 dB roundtrip loss, and FUT-to-multicore splice near the GRIN lens has a splice loss ranging from 0.3 to 1.4 dB. Also, the grating reflectivity was ˜2-3 dB lower in Core 3 and Core 4.

Precise shape reconstruction requires the measurement of local curvature and twist along the fiber, typically with spatial resolution of less than 1 mm (80 μm in this work). These parameters are derived from the strain field over the fiber cross section. To measure the local strain, we extract data from the first four cores of the OFDR trace in FIG. 16A. The trace for Core 1 is taken from the measurement in FIG. 16A by cropping before Splice 1 and after the first turnaround at 8.5 m. The trace for Core 2 is obtained by cropping off the data before the turnaround and after Splice 2 and then inverting the trace. The traces for Core 3 and Core 4 are generated in a similar fashion. Core 3 is cropped between Splice 2 and the second turnaround at 20 m. Core 4 is cropped between the second turnaround and Splice 3 then spatially reversed. The four traces are then translated so that they are all aligned at the location of the turnaround, and splice 1 is at just after z=0. The various components of the system can be seen aligned in FIG. 16B. The turnaround point is aligned at ˜5.6 m, splices into the multicore fiber are aligned near 2.6 m, and the tapered region of the TFB is aligned at ˜2 m. Note that the splices among the single core fanout outputs do not occur exactly at the halfway point between the micro-turnaround points. This is because the single core pigtails in the fanout are not exactly the same length. Therefore, unlike the turnaround and the multicore splice to the fanout, the reflections from these points are not at the same location for each trace. These reflections may combine with the other reflection spikes to generate spurious peaks in the traces. Such reflection artifacts may also arise from stray reflections at the GRIN micro-turnaround.

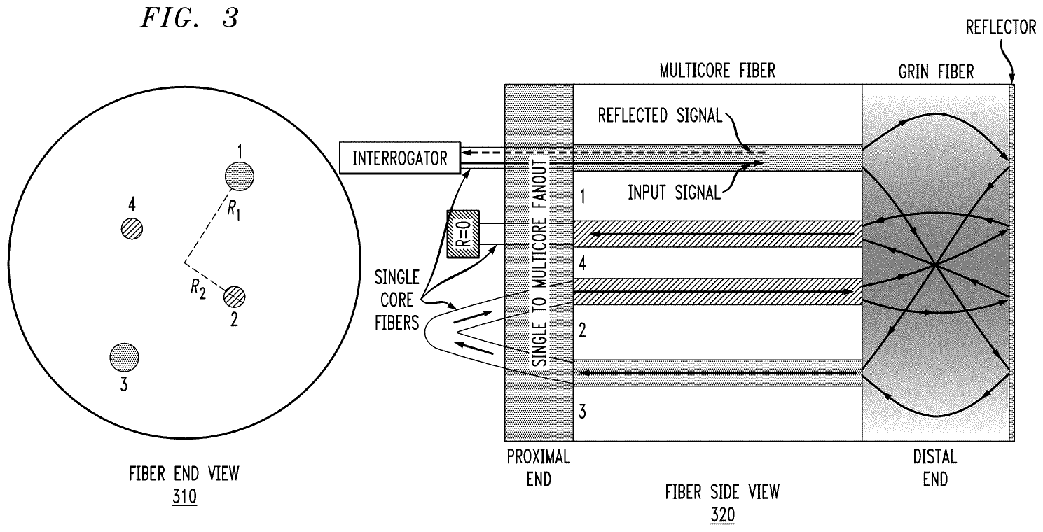

OFDR processing, as described above, will convert the phase data for these traces into a local Bragg wavelength using Eq. 2. FIG. 2(c) shows the difference in local Bragg wavelength, Δλ_{Bragg}(z), for a straight fiber and a fiber experiencing constant curvature. When a fiber is bent, one side of the fiber is under tension, while the other side is under compression. With the outer cores rotating along the fiber, Δλ_{Bragg}(z) will give a sine wave profile, since each outer core will alternate between tension and compression through one twist period of ˜2 cm. Note that Δλ_{Bragg}(z) for Core 1 and Core 2 are anti-phase from each other as the cores are 180° apart, which also holds true for Core 3 and Core 4. Moreover, the oscillations in Core 1 (and Core 2) are 60 degrees out of phase with respect to Core 3 (and Core 4) since these cores are rotated by 60 degrees with respect to each other. By knowing the local changes in Bragg wavelength, the strain of the outer cores can be then computed with the equation

$$ε ( z ) = \frac{1}{η} \frac{Δ {λ}_{Bragg} ( z )}{{λ}_{Bragg}} ,$$

where ε is the strain experienced by the core and η˜0.69 accounts for the strain-optic effect. Unlike other shape sensing fiber core configurations [15], our fiber plus the turnaround device provides no signal from the center core. The center core provides a reference since it does not undergo strain when the fiber is bent. In our analysis, we obtained a reference value of λ_{Bragg} in a calibration step in which the fiber is measured while being held completely straight with no added axial strain.

According to exemplary embodiments of the present invention, the fiber shape reconstruction may be performed by integrating the Frenet-Serret equations:

$$\dot{S} = [ \begin{matrix}0 & κ ( s ) & 0 \\ - κ ( s ) & 0 & τ ( s ) \\ 0 & - τ ( s ) & 0\end{matrix} ] S \# \qquad ( 3 )$$

where S≡[T(s); N(s); B(s)], and \dot{S}=dS/ds. The parameter s is related to the curve formed by the fiber r(x, y, z) through its differential: ds=|dr(x, y, z)|. These equations relate the local curvature κ(s) and torsion τ(s) to the tangent T(s), normal N(s) and binormal B(s) vectors. The fiber shape is related to the tangent vector through: T=dr(s)/ds, and r(s)=∫₀^{L} T(s)ds. The exemplary shape reconstruction may rely on certain assumptions. For instance, mechanical twist of the fiber about its axis may be neglected and that the torsion parameter τ(s) arises solely from variation in the direction of the bend axis, N(s), along the fiber. In addition, the fiber may have non-zero curvature so that the differential strain of the offset cores is sufficiently large that the parameters κ(s) and τ(s) may be computed from the variation of the outer core Bragg wavelengths.

To calculate κ(s) and τ(s), the vectors pointing to the helically twisting cores, \hat{ρ}ᵤ(s) must be accurately determined along the fiber (FIG. 16D). Although the fiber has an average twist rate of 50 twists per meter, the local twist rate can vary due to fiber manufacture. Thus, another calibration step is performed. The fiber is carefully placed on a flat plane surface to not introduce external twist while it is continuously bent. By measuring the local variation of Δλ_{Bragg} (s), the vectors pointing to the cores locally, \hat{ρ}ᵤ(s), can be determined. This set of values of \hat{ρ}ᵤ(s) are then taken as the local reference coordinates, \hat{ρ}ᵤ^{ref}(s), to compute the curvature when the fiber is in an arbitrary shape. Using the distributed strains εᵤ(s) of the outer cores, a local curvature vector, \vec{κ}(s), of the FUT can be calculated from these reference vectors using the relation:

$$\vec{κ} ( s ) = \frac{1}{γ} {\sum }_{u = 1}^{N} {\hat{ρ}}_{u}^{ref} ( s ) {ε}_{u} ( s ) ,$$

where r is the distance between the center core and outer cores, N=4 is the number of cores, and u is the label of the core. After \vec{κ}(s) is calculated, the bend angle, θ(s), along the fiber may be determined as well. Since this fiber is under non-zero curvature, this bend angle can be calculated by the difference in angle of \hat{ρ}ᵤ^{ref} (s) and \hat{ρ}ᵤ(s). The local torsion can then be determined with the following: τ(s)=d{θ(s)}/ds. These values are then used in the Frenet-Serret Equations (See Eq. (3) above) to compute T(s) and the fiber shape. It may be assumed that the initial conditions are κ(0)=0 and τ(0)=0. Also, T(0), N(0), and B(0) are three arbitrarily chosen orthonormal unit vectors. In our case, we chose T(0)=[0 0 1] for the initial fiber to point in the z-direction.

As shown in FIGS. 16A-D, the output of the OFDR is spliced into the TFB fanout fiber corresponding to Core 1 of the FUT (Splice 1). A small increase in backscattered signal is observed at Splice 1 because of the difference in Rayleigh scattering between the output fiber of the OFDR (SMF-28) and the TFB fanout fiber. A spike in the OFDR trace after the splice is due to the tapered region of the TFB. The multicore side of the fanout is spliced to the FUT. The enhanced backscattered signal of the FUT from the continuous gratings is clearly seen (Core 1). The GRIN fiber turn-around device, spliced to the distal end of the FUT, appears as a spike, followed by a drop in signal due to GRIN fiber attenuation and reflection loss. The signal is then flipped with respect to the signal from Core 1 and will propagate towards the fanout at the proximal end of the FUT (Core 2). The output of the Core 2 fanout is spliced to the Core 3 fiber of the fanout. Signals in Core 3 and Core 4 will also propagate in a similar fashion as Core 1 and Core 2, although with lower amplitude due to various losses. Although Core 5 and Core 6 were spliced to the setup and can be seen in the OFDR trace, they were not used in this set of experiments because the signal degraded too much due to the losses in the system. According to one embodiment, each GRIN reflection may cause a loss of ˜1.6 dB and each pass between TFB to FUT splice may cause a loss ranging from 0.8 to 2.2 dB. According to additional embodiments, an acceptable amount of loss caused by exemplary GRIN fibers and by the exemplary splices maybe less than 5.0 dB, more specifically, less than 3.0 dB. Furthermore, the loss of an exemplary multicore fiber assembly featuring the use of multiple turnarounds may be less than 20 dB. For example, as illustrated in FIG. 16C, the overall attenuation from Core 1 (˜82 dB) to Core 4 (˜100 dB) is less than 20 dB.

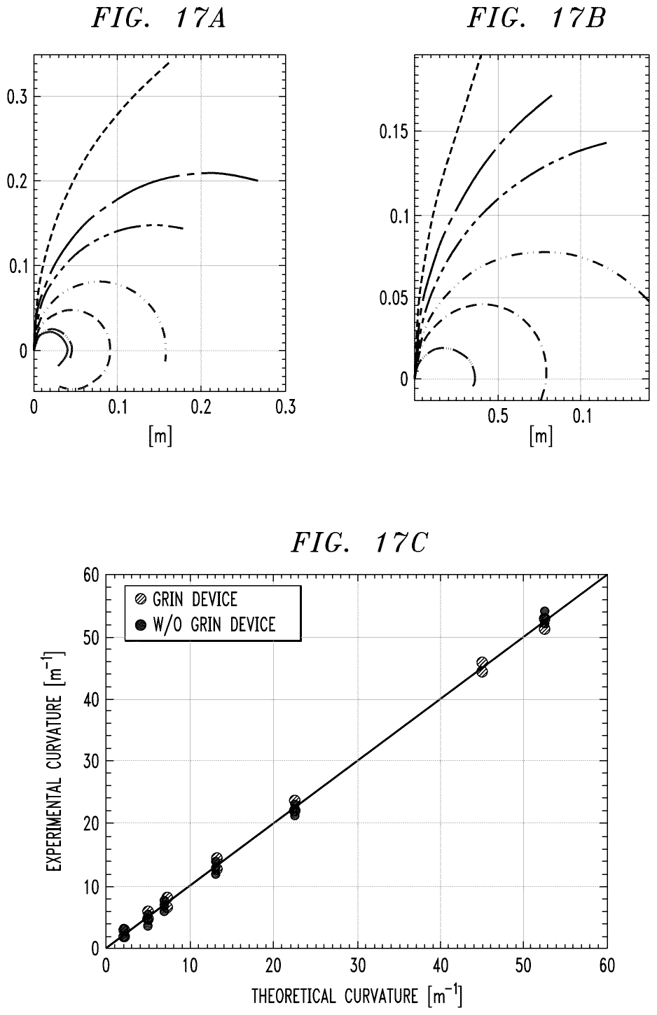

FIG. 17A-C illustrates reconstruction of FUT under various curvatures with GRIN turn-around device (FIG. 17A) and without the device (FIG. 17B); as well as a comparison of curvature results (FIG. 17C) for current and previous shape sensing systems. FIG. 17A shows the current shape sensing system tested against several curvatures. The FUT was wrapped around spools of various diameters with a minimal twist to test its performance, ranging from 52 m⁻¹ to 2.2 m⁻¹. The current shape sensing system is also compared against one where the fiber does not have a GRIN turn-around device and each core is interrogated individually with the use of an optical switch. As shown in FIG. 17C, the curvature sensing capability of the current system is accurate and comparable to past systems as they are in good agreement with each other and with the theoretical value.

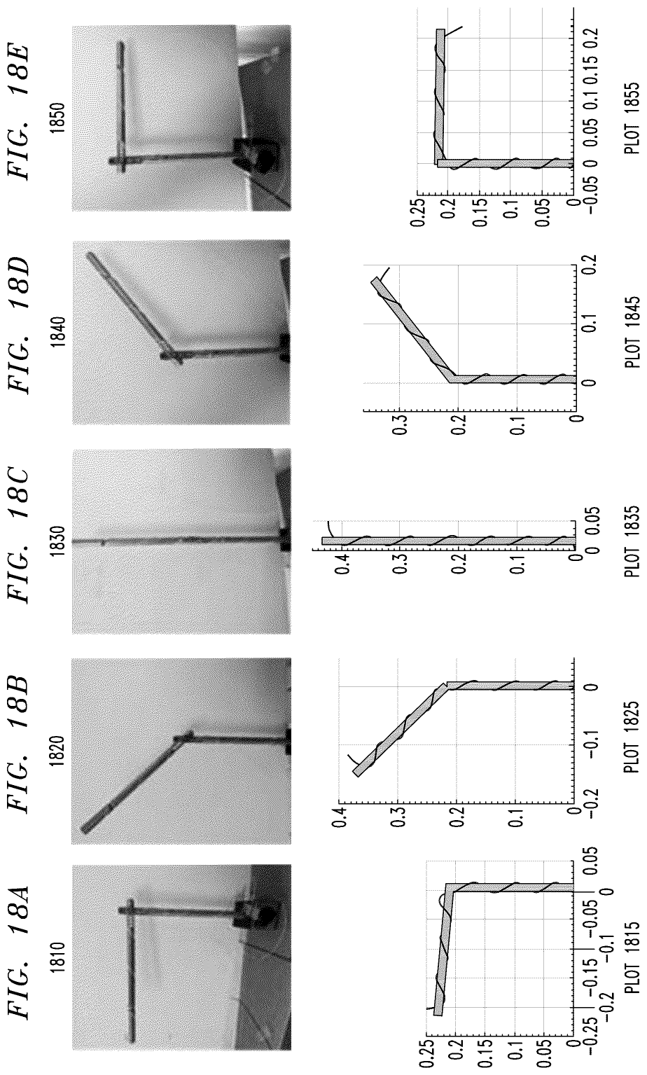

FIGS. 18A-E illustrate photos 1810-1850 and corresponding shape reconstructions plots 1815-1855 of fiber wrapped around two posts at different angles: −90° (FIG. 18A), −45° (FIG. 18B), 0° (FIG. 18C), 45° (FIG. 18D), and 90° (FIG. 18E). Accordingly, these figures show the capability of the current system in 3D shape sensing. In one embodiment, the fiber may exhibit nonzero curvature since the curvature is needed to measure the twist. Note that this is not a limitation of the single-ended shape sensor system but a limitation on the current fiber on twist sensitivity. It is possible to design the fiber with a higher twist sensitivity and still have a turn-around at the distal end. The fiber was wrapped helically around two optical posts in order for the fiber to have curvature throughout its length. These two posts were then bent at five different angles (−90°, −45°, 0°, 45°, and 90°) and the shape reconstruction plots 1815-1855 is shown in FIG. 18A-E. Cylinders may be added to the shape reconstruction to show that the reconstructed shape was indeed wrapping around a straight cylinder. Since the shape reconstruction gives an arbitrary frame, the bottom post may be used as a reference. The shape reconstruction in each case was rotated so that the axis around which the bottom spiral rotated was always in the same orientation, and the azimuthal orientation of the top post was always the same. Qualitatively, the reconstructions are well matched to the pictures of the fiber. All the reconstructions are wound neatly around both posts, where the curvatures are not significantly larger or smaller than the half-inch posts. Also, each reconstruction shows six fiber revolutions around the posts, the same as shown in the pictures. For a more quantitative result, a top post was created virtually and fitted against the reconstructed shape to give an estimate of the angle between the posts, which provides angles of −85°, −44°, 0°, 52°, and 91°. It is noted that a precise wrapping of the posts is not necessary, and the fiber was not bonded with the posts during the entire experiment.

In conclusion, the exemplary embodiments described herein present a novel single-channel interrogation technique of multicore fibers for use in curvature and shape sensing. By using a GRIN micro-turnaround device that is spliced to the distal end of a multicore fiber, multiple cores in a single fiber may be interrogated simultaneously without the need of an optical switch. It has been shown that the curvature measurements are accurate and comparable to the traditional multi-channel method. Furthermore, the capabilities of this novel system have been demonstrated with several shape-sensing examples. These results show it is possible to lower the complexity and increase the acquisition speed of traditional shape sensor devices, which are relevant in the medical, aerospace, structural monitoring industries, etc.

The present disclosure has been described with reference to exemplary embodiments thereof. All exemplary embodiments and conditional illustrations disclosed in the present disclosure have been described to intend to assist in the understanding of the principle and the concept of the present disclosure by those skilled in the art to which the present disclosure pertains. Therefore, it will be understood by those skilled in the art to which the present disclosure pertains that the present disclosure may be implemented in modified forms without departing from the spirit and scope of the present disclosure. Although numerous embodiments having various features have been described herein, combinations of such various features in other combinations not discussed herein are contemplated within the scope of embodiments of the present disclosure.

What is claimed is:

1. A multicore fiber assembly transmitting an input signal from an interrogator in multiple directions, the multicore fiber assembly comprising:
a multicore waveguide receiving the input signal from the interrogator;
a multicore fanout coupled to a proximal end of the multicore waveguide, the multicore fanout positioned to propagate the input signal in a first direction along a first core of the multicore waveguide;
a first turnaround coupled to a distal end of the multicore waveguide for redirecting the input signal at a distal end of the first core of the multicore waveguide, wherein the input signal is redirected in a second direction along a second core of the multicore waveguide; and
a second turnaround coupled to multicore fanout for redirecting the input signal at the multicore fanout, wherein the input signal is redirected in the first direction along a third core of the multicore waveguide;
wherein the input signal from the third core of the multicore waveguide is redirected by the first turnaround in the second direction along a fourth core of the multicore waveguide toward the multicore fanout, and the waveguide propagates a distributed back-reflected signal to the interrogator.

2. The multicore fiber assembly described in claim 1, wherein an attenuation loss in the input signal from the first turnaround to the second turnaround is less than 5 dB.

3. The multicore fiber assembly described in claim 1, wherein an attenuation loss in the input signal from the first core to the fourth core is less than 20 dB.

4. The multicore fiber assembly described in claim 1, wherein the input signal is a single signal received by the interrogator.

5. The multicore fiber assembly described in claim 1, wherein the input signal from the interrogator is coupled to the fiber assembly in both directions, and the interrogator collects signal from one or both directions.

6. The multicore fiber assembly described in claim 1, wherein the interrogator is a Brillouin Optical Time Domain Analysis (BOTDA) interrogator.

7. The multicore fiber assembly described in claim 1, wherein the interrogator is an Optical Frequency domain reflectometry (OFDR) interrogator.

8. The multicore fiber assembly described in claim 1, wherein at least one of the first and second turnarounds is a GRIN lens having a length of less than 5 mm.

9. The multicore fiber assembly described in claim 8, wherein the GRIN lens further includes a reflector coupled to the distal end of the GRIN lens wherein the reflector is dichroic.

10. The multicore fiber assembly described in claim 1, wherein the second turnaround is a single core fiber coupled to the multicore fanout.

11. The multicore fiber assembly described in claim 1, wherein at least two cores are offset from a center of the multicore fiber by a radius of R1 and at least a further two cores are offset from the center of the multicore fiber by a radius of R2, wherein R1≠R2.

12. An optical system for transmitting a signal in multiple directions within a multicore fiber sensor, the optical system comprising:
an interrogator;
a multicore fiber having a proximal end, a distal end, and a plurality of single-mode cores;
a single core to multicore fanout coupled to the proximal end of the multicore fiber;
a GRIN lens coupled to the distal end of the multicore fiber, wherein the GRIN lens has a length of less than 5 mm; and
a micro-turnaround affixed to the multicore fanout,
wherein the multicore fiber is configured to:
a) receive a signal from the interrogator via the multicore fanout coupled to the proximal end of the multicore fiber,
b) propagate the signal in a first direction along at least one core of the multicore fiber,
c) redirect the signal at the GRIN lens coupled to the distal end of the multicore fiber in a second direction, and
d) propagate a distributed back-reflected signal to the interrogator.

13. The optical system described in claim 12, wherein an attenuation loss in the signal from the first direction to the second direction is less than 5 dB.

14. The optical system described in claim 12, wherein an attenuation loss in the signal transmitted through the micro-turnaround is less than 20 dB.

15. The optical system described in claim 12, wherein the signal is a single signal received by the interrogator.

16. The optical system described in claim 12, wherein the signal from the interrogator is coupled to the multicore fiber in both directions, and the interrogator collects the signal from one or both directions.

17. The optical system described in claim 12, wherein the interrogator is a Brillouin Optical Time Domain Analysis (BOTDA) interrogator.

18. The optical system described in claim 12, wherein the interrogator is an Optical Frequency domain reflectometry (OFDR) interrogator.

19. The optical system described in claim 12, wherein at least two cores are offset from a center of the multicore fiber by a radius of R1 and at least a further two cores are offset from the center of the multicore fiber by a radius of R2, wherein R1≠R2.

20. The optical system described in claim 12, wherein at least two cores are twisted about a central axis of the multicore fiber.

21. The optical system described in claim 12, wherein at least one core includes index perturbations along their length to modify the multicore.

22. The optical system described in claim 12, wherein the multicore fiber includes at least one multimode core.

23. The optical system described in claim 22, wherein the GRIN lens further includes a reflector coupled to the distal end of the GRIN lens wherein the reflector is dichroic.

24. The optical system described in claim 12 further includes a center core inside the multicore fiber, and an intermediate fiber between the multicore fiber and the GRIN lens, wherein non-centered outer cores of the intermediate fiber have the same structures of the non-centered outer cores of the multicore fiber.

25. The optical system described in claim 12, at least the multicore fiber and the GRIN lens are coated with a stray reflection absorbent material.

26. The optical system described in claim 12, wherein the optical system further includes an optical isolator between the multicore fiber and the interrogator, the optical isolator receives the propagated distributed back-reflected signal from the multicore fiber before fed back to the interrogator.

27. A method of transmitting a single signal in multiple directions within a multicore fiber sensor, the method comprising:
a) receiving, at the multicore fiber sensor, a signal from an interrogator via a multicore fanout coupled to a proximal end of the multicore fiber sensor;
b) propagating the signal in a first direction along a first core of the multicore fiber sensor;
c) redirecting the signal at a GRIN lens coupled to a distal end of the multicore fiber sensor, wherein the GRIN has a length of less than 5 mm;
d) propagating the signal in a second direction along a second core of the multicore fiber sensor;
e) redirecting the signal at a single core turnaround coupled to the multicore fanout;
f) propagating the signal in the first direction along a third core of the multicore fiber sensor;
g) redirecting the signal at the GRIN lens;
h) propagating the signal in the second direction along a fourth core of the multicore fiber sensor toward the multicore fanout; and
i) propagating a distributed back-reflected signal to the interrogator.

28. The method described in claim 27, further comprising:
terminating the signal at a single-mode fiber of the multicore fanout.

29. The method described in claim 27, wherein the signal from the interrogator is coupled to the multicore fiber in both directions, and the interrogator collects the signal from one or both directions.

30. The method described in claim 27, further comprising:
transmitting the signal to an optical spectrum analyzer; and
monitoring a change of spectrum through the multicore fiber sensor.
